(19) United States
(12) Patent Application Publication
(10) Pub. No.: US 2026/0148090 A1
(43) Pub. Date: May 28, 2026

(54) SYSTEMS AND METHODS FOR AGGREGATION AND ROUTING USING MULTIPLE AI/ML TECHNIQUES

(71) Applicant: Verizon Patent and Licensing Inc., Basking Ridge, NJ (US)

(72) Inventors: Mason Ng, Jersey City, NJ (US); Mourad B. Takla, Hillsborough, NJ (US); Sugandha Venkatachalam, Plano, TX (US); Scott E. Thornton, Owasso, OK (US)

(73) Assignee: Verizon Patent and Licensing Inc., Basking Ridge, NJ (US)

(21) Appl. No.: 18/959,900

(22) Filed: Nov. 26, 2024

(51) Int. Cl. G06N 3/098; G06N 3/0985

(52) U.S. Cl. CPC G06N 3/098; G06N 3/0985

(57) ABSTRACT

A system described herein may establish communications with a plurality of artificial intelligence/machine learning ("AI/ML") systems; provide an interface to a plurality of client devices; receive, via the interface and from a particular client device, of the plurality of client devices, a particular input; select, based on one or more input handling models, a particular subset of AI/ML systems to which the particular input should be forwarded; output the input to the selected subset of AI/ML systems; receive a set of outputs that are each associated with a particular AI/ML system of the selected subset of AI/ML systems; and output, via the interface and to the particular client device, at least one of one or more outputs, of the set of outputs received from the selected subset of AI/ML systems, or an aggregated output that is generated based on the set of outputs received from the subset of AI/ML systems.

### BACKGROUND

Artificial intelligence/machine learning ("AI/ML") provides advanced processing of inputs in order to generate optimal outputs. Different AI/ML techniques such as language models (e.g., small language models ("SLMs"), large language models ("LLMs"), personal language models ("PLMs"), or the like), image recognition, computer vision, neural networks, clustering, Natural Language Processing ("NLP"), or the like, may perform different types of processing in order to provide responses such as classifications, natural language responses, procedurally generated responses, or the like. As such, different AI/ML techniques may be applicable in different situations, such as for different types of input or for different types of desired output.

### BRIEF DESCRIPTION OF THE DRAWINGS

FIG. 1 illustrates an example overview of one or more embodiments described herein;

FIG. 2 illustrates an example of a communication pathway for a network to provide network information to a unified AI/ML platform of some embodiments;

FIGS. 3-5 illustrate examples of processing an input using one or more different AI/ML systems, in accordance with some embodiments;

FIG. 6 illustrates an example of providing a seamless unified API that facilitates access to processing services of multiple AI/ML systems, in accordance with some embodiments;

FIGS. 7 and 8 illustrate example environments in which one or more embodiments, described herein, may be implemented;

FIG. 9 illustrates an example arrangement of a radio access network ("RAN"), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for a unified AI/ML platform that serves as a single interface for multiple AI/ML systems, each of which may implement multiple different AI/ML techniques and/or may implement the same type of AI/ML technique. For example, as shown, unified AI/ML platform 101 may establish, manage, maintain, etc. (at 102) communications with multiple different AI/ML systems 103 (e.g., AI/ML systems 103-1, 103-2, 103-M, etc.). Unified AI/ML platform 101 may, for example, perform a registration procedure, an authentication procedure, a configuration procedure, and/or some other suitable set of procedures with each AI/ML system 103 in order to establish communications with such AI/ML system 103.

As discussed herein, unified AI/ML platform 101 may communicate with one or more client devices 105 (e.g., client devices 105-1, 105-2, 105-N, etc.), such as via unified application programming interface ("API") 107, to provide selective and/or aggregated processing of one or more AI/ML systems 103 in response to processing requests or other inputs from client devices 105. Applications, operating systems, and/or other elements of client devices 105 may, for example, access unified AI/ML platform 101 via unified API 107. In this manner, individual client devices 105 (e.g., applications executing thereon) may gain access to multiple AI/ML systems 103 (e.g., which may potentially be associated with or provided by multiple different entities) without needing to themselves maintain respective interfaces or other communication pathways with AI/ML systems 103 (e.g., unified AI/ML platform 101 may establish, update, configure, etc. such interfaces "in the background" or otherwise transparently from the standpoint of client devices 105). Further, unified AI/ML platform 101 may itself utilize AI/ML techniques in order to select particular AI/ML systems 103 that are suitable to process respective inputs from client devices 105, where such selection may be based on attributes of client devices 105, attributes of the inputs themselves, and/or other factors. Further, unified AI/ML platform 101 may utilize multiple AI/ML techniques (e.g., based on processing by multiple AI/ML systems 103) to generate optimal responses, with or without an explicit request from client device 105, thus potentially providing higher quality or otherwise more optimal responses than may be generated by utilizing the techniques of only a single AI/ML system 103.

As such, in accordance with some embodiments, client devices 105 may be able to receive optimal outputs in response to inputs, without needing to specify particular AI/ML systems 103 and/or AI/ML techniques to perform in order to generate such responses. On the other hand, unified AI/ML platform 101 may also provide for client devices 105 to explicitly request the use of one or more AI/ML systems 103 and/or AI/ML techniques in order to generate responses to particular inputs, which may be particularly useful in a variety of situations such as in which a given client device 105 (and/or a user thereof) is "aware" of a particular AI/ML technique to be used but has not established a communication pathway with an associated AI/ML system 103 that implements or provides such technique. As noted above, client devices 105 are insulated from experiencing any technical hurdles, costs, or other difficulties associated with establishing communication pathways with multiple AI/ML systems 103, by way of having access to the services provided by such AI/ML systems 103 via unified AI/ML platform 101 and unified API 107.

In some embodiments, one or more AI/ML systems 103 may be implemented by separate devices or systems than each other and/or then unified AI/ML platform 101. For example, unified AI/ML platform 101 may be implemented by a first device or system (e.g., a first set of hardware resources, a first cloud computing system, or the like), AI/ML system 103-1 may be implemented by a second device or system, AI/ML system 103-2 may be implemented by a third device or system, or the like. In some embodiments, unified AI/ML platform 101 and/or one or more AI/ML systems 103 may be implemented by the same device or system. For example, in some such embodiments, unified AI/ML platform 101 and AI/ML system 103-1 may be implemented by the same device or system, AI/ML systems 103-1 and 103-2 may be implemented by the same device or system, etc. In some embodiments, unified AI/ML platform 101 and/or one or more AI/ML systems 103 may be implemented by one or more Multi-Access/Mobile Edge Computing ("MEC") devices, referred to sometimes herein simply as "MECs," that are included in or are communicatively coupled to a RAN of a wireless network. In some embodiments, unified AI/ML platform 101 and/or one or more AI/ML systems 103 may be implemented by one or more User Equipment ("UEs") that are registered with wireless network 111, one or more Network Functions ("NFs") of wireless network 111, a cloud system, and/or one or more other suitable devices or systems.

As shown, unified AI/ML platform 101 may, in some embodiments, request and/or receive information from one or more information sources 109, such as wireless network 111, one or more application servers 113, database 115, one or more other types of networks (e.g., wireline networks, data networks, etc.), and/or other suitable information sources. In some embodiments, unified AI/ML platform 101 may receive information from one or more information sources 109 on an ongoing basis (e.g., periodically, intermittently, etc.), on an event-driven basis, based on a polling operation, and/or on some other basis.

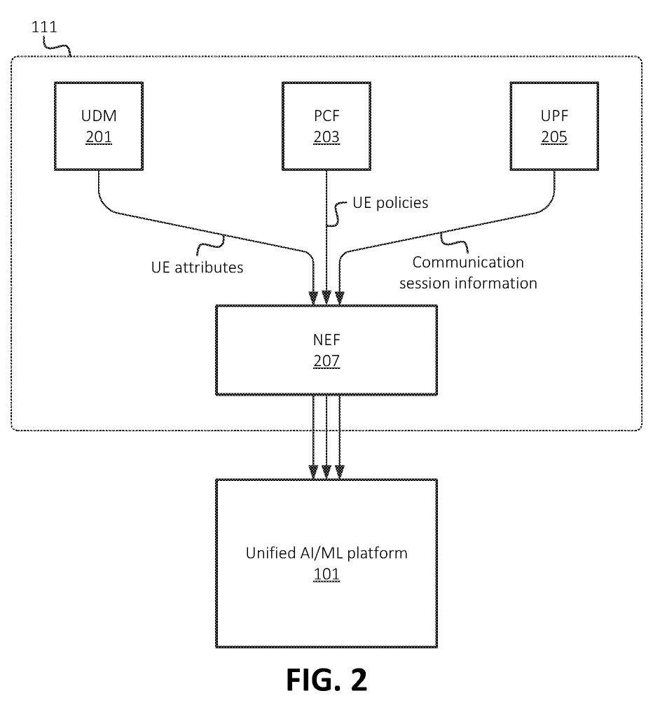

As shown in FIG. 2, one or more information sources 109 may include NFs of wireless network 111, such as Unified Data Management function ("UDM") 201, Policy Control Function ("PCF") 203, and/or User Plane Function ("UPF") 205. In some embodiments, unified AI/ML platform 101 may communicate with UDM 201, PCF 203, UPF 205, and/or other elements of wireless network 111 via Network Exposure Function ("NEF") 207, which may serve as a secure interface between wireless network 111 and devices or systems that are external to wireless network 111, such as unified AI/ML platform 101 in some embodiments. In some embodiments, for example, unified AI/ML platform 101 may communicate with NEF 207 via a Transmission Control Protocol ("TCP") communication pathway, an Internet Protocol ("IP") communication pathway, and/or some other suitable communication pathway for transporting traffic between unified AI/ML platform 101 and NEF 207.

Information from information sources 109, such as NFs of wireless network 111, may include information such as client device information and/or policies, such as attributes of one or more particular client devices 105. For example, a particular client device 105 may be, may include, or may be implemented by a UE that is registered with or provisioned by a particular wireless network 111 (e.g., wireless network 111 may be a "home" network of the UE). In one example, client device information and/or policies include UE attribute information (e.g., as provided by UDM 201), UE policies (e.g., as provided by PCF 203), and/or communication session information (e.g., as provided by UPF 205).

Attributes of a particular client device 105 (e.g., of a particular UE) may include an identifier such as an International Mobile Subscriber Identity ("IMSI") value, an International Mobile Station Equipment Identity ("IMEI") value, a Mobile Directory Number ("MDN"), an IP address, a device name, and/or some other suitable identifier. In one example, the attributes of client device 105 (e.g., UE information provided by UDM 201) may include device type (e.g., smartphone, Internet of Things ("IoT") device, automated guided vehicle ("AGV"), or the like), device category (e.g., "first responder," "enterprise," etc.), tags or labels, location information (e.g., current tracking area ("TA") of a wireless network, latitude and longitude coordinates, street address, historical device profile information, etc.), and/or other suitable attributes.

In some embodiments, UE policies (e.g., as provided by PCF 203) may include policies such as services authorized or not authorized for specific client devices 105 (e.g., UEs), AI/ML systems 103 for which client devices 105 are authorized or not authorized, temporal conditions for access to particular AI/ML systems 103 (e.g., days of the week, hours of the day, etc. that client devices 105 are authorized to access respective AI/ML systems 103), and/or other types of policies. In some embodiments, communication session information (e.g., as provided by UPF 205) may include information such as quantity of active communication sessions (e.g., quantity of protocol data unit ("PDU") sessions) associated with a given UE (e.g., a given client device 105), network slice information of one or more communication sessions associated with a given UE, amount of traffic sent to or received from a given UE (e.g., bandwidth), and/or other communication session information. In some embodiments, these NFs and/or one or more other NFs of wireless network 111 may provide additional or different types of information to unified AI/ML platform 101 (e.g., via NEF 207 and/or some other suitable communication pathway).

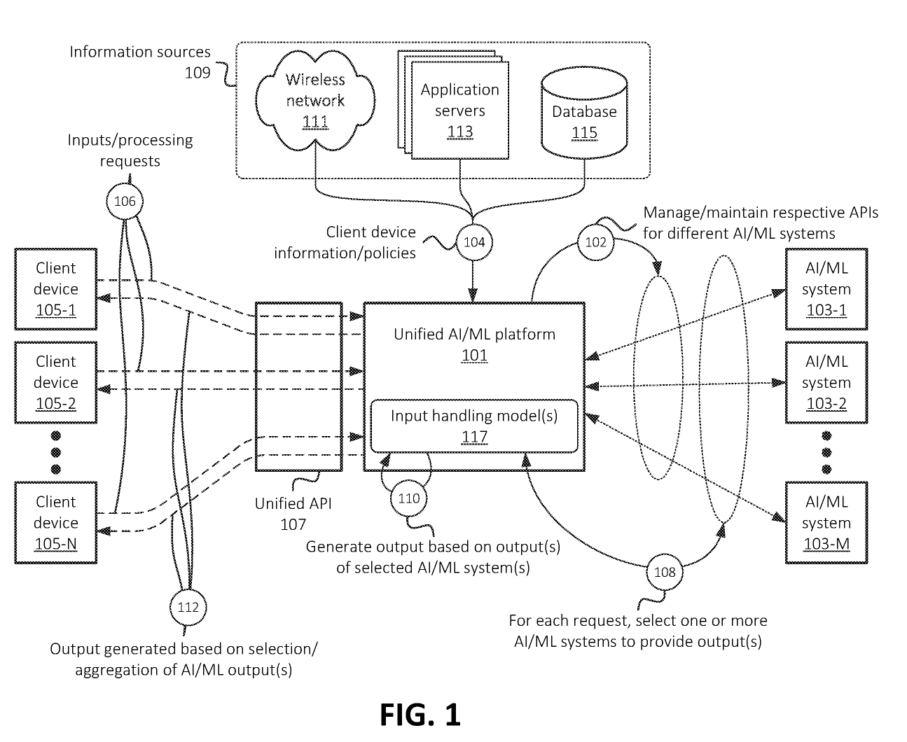

Returning to FIG. 1, unified AI/ML platform 101 may additionally, or alternatively, receive other types of information from application servers 113, database 115, a web crawler, and/or other suitable information sources 109. For example, unified AI/ML platform 101 may receive road traffic information associated with one or more locations, weather information associated with one or more locations, information regarding news or other current events, and/or other suitable types of information. As discussed below, the information received (at 104) from information sources 109 may be used by unified AI/ML platform 101 in determining how to appropriately handle processing requests and/or other inputs received (at 106) from one or more respective client devices 105.

As some examples, inputs (e.g., as received at 106) may take a variety of forms or request types, such as a request to provide a textual description of an input image, a request to generate computer code based on an image or flowchart, a request to aggregate or summarize the results of one or more Internet searches, a natural language prompt or other element of natural language, a request to classify a set of data, a request to generate a predicted outcome given a set of input variables, a request that includes a prompt or key word associated with a language model, and/or other suitable input information.

The inputs may be received by unified AI/ML platform 101 via unified API 107. For example, client devices 105 may register with unified AI/ML platform 101 (e.g., register with unified API 107), implement functionality associated with unified API 107, access unified API 107 via a web portal or application, and/or otherwise provide (at 106) processing requests or other inputs to unified AI/ML platform 101 via unified API 107. As noted above, communicating with unified AI/ML platform 101 via unified API 107 may remove the need for client devices 105 to register individually with multiple AI/ML systems 103.

As further shown, unified AI/ML platform 101 may, for each processing request or input, unified AI/ML platform 101 may select (at 108) one or more AI/ML systems 103 to process the input and to generate output data. In some embodiments, unified AI/ML platform 101 may receive, maintain, refine, etc. one or more input handling models 117, which unified AI/ML platform 101 may further utilize in order to determine how to handle respective inputs (received at 106) from client devices 105. Input handling models 117 may, for example, associate attributes of processing requests or inputs (e.g., as received from client devices 105) to a set of AI/ML systems 103 (e.g., a particular AI/ML system 103 and/or a combination of multiple AI/ML systems 103), which may be an optimal set of AI/ML systems 103 to generate outputs for such processing requests or inputs.

As one example, the content of a given processing request or input may be a factor based on which a respective AI/ML system 103 (or group of AI/ML systems 103) may be selected (at 108) to handle such input. The content may include, for example, key words or phrases, a language-based intent, file type(s) of file(s) included in or referenced by the input, a size of the input (e.g., a file size of the input, amount of storage resources consumed to store or cache the input, and/or some other measure of size), or other content-based attributes of respective inputs.

In one example, information associated with a given client device 105, from which a given input is received, may be a factor based on which a respective AI/ML system 103 (or group of AI/ML systems 103) may be selected (at 108) to handle such input. Such information may include, for example, UE information, policies, communication session information, location information, usage limits, and/or other suitable information received (at 104) from wireless network 111. In some embodiments, the information regarding a given client device 105 may be received from one or more other sources, such as one or more application servers 113, database 115, or the like. For example, a particular client device 105 may receive a service from application server 113 (e.g., a videoconferencing service, a vehicle navigation service, a content streaming service, and/or some other service), and application server 113 may provide (at 104) information to unified AI/ML platform 101 associated with such service. Such information may include (i.e., with consent of a user of client device 105), a description or category of a service provided to client device 105 by application server 113, an amount of bandwidth of traffic between client device 105 and application server 113, and/or other information regarding a service provided to client device 105.

In some embodiments, application server 113 and/or database 115 may include additional or different information, such as information that is not necessarily associated with or tied to a particular client device 105. For example, such information may include weather information associated with one or more geographical regions, road traffic information associated with one or more geographical regions, information regarding news or current events, search engine analytics or other search engine information, vector database information, content document ranking indices, confidential user information securely maintained on an on-premises datacenter and available only with user consent, etc.

In some embodiments, unified AI/ML platform 101 may perform a training operation and/or other suitable operation to generate or refine input handling models 117 (e.g., may utilize AI/ML techniques over time), in order to determine optimal AI/ML systems 103 (or combinations of AI/ML systems 103) to handle varying types of inputs with a variety of different content, from different client devices 105 and/or types or categories of client devices 105, and/or other suitable conditions such as device location or other external factors such as weather or road traffic information.

In some embodiments, an "optimal" set of AI/ML systems 103 for a given input (e.g., as determined based on input handling models 117) may include a single AI/ML system 103. As one example, as indicated by input handling models 117, an input that is determined to be of a particular type (e.g., a natural language prompt) may be determined as being optimally handled by a particular AI/ML system 103, such as AI/ML system 103-1, which may be an NLP-based and/or LLM-based AI/ML system 103 (e.g., may maintain one or more NLP and/or LLM models, and/or may utilize NLP and/or LLM techniques). As another example, as indicated by input handling models 117, an input of a particular type and with a first set of key words or prompts (e.g., associated with a first language-based intent) may be determined as optimally handled by a first LLM-based AI/ML system 103 (e.g., AI/ML system 103-1), while another input of the same type and associated with a second set of key words or prompts (e.g., associated with a second language-based intent) may be determined as optimally handled by a different, second LLM-based AI/ML system 103 (e.g., AI/ML system 103-2). For example, based on the training operation, unified AI/ML platform 101 may have trained input handling model 117 to identify that more optimal outcomes are reached based on the example selection described above.

Input handling model 117 may generate or identify (at 110) outputs in response to the inputs (received at 106), and may provide (at 112) such outputs to client devices 105. As discussed below, the outputs provided to client devices 105 may be the output of a particular AI/ML system 103, the aggregated output of multiple AI/ML systems 103, and/or may be an output generated by unified AI/ML platform 101 based on the output of one or more AI/ML systems 103.

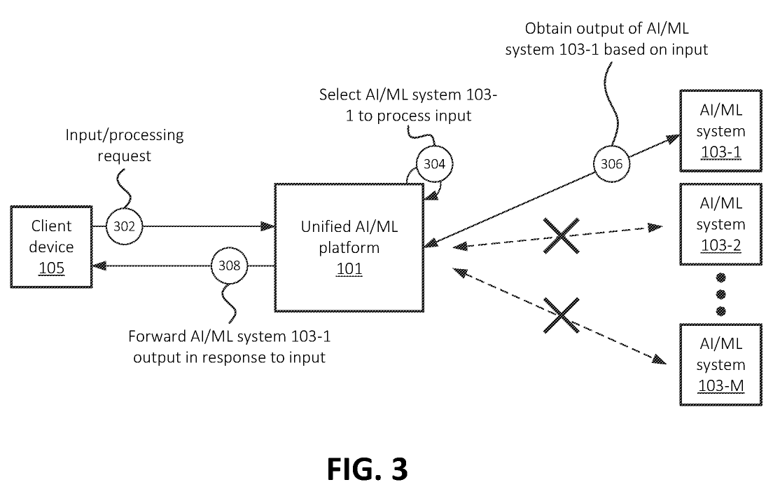

FIG. 3 illustrates one example of selecting a particular AI/ML system 103 to handle a particular input (e.g., as received (at 302). In this example, unified AI/ML platform 101 may select (at 304) AI/ML system 103-1 to process the particular input. In this example, unified AI/ML platform 101 may identify that AI/ML system 103-1 is the only AI/ML system 103 (e.g., out of a set of candidate AI/ML systems 103) that implement suitable AI/ML techniques for the type of input, for the content of the input, for attributes of the particular client device 105, etc. As another example, unified AI/ML platform 101 may select AI/ML system 103-1 based on some other measure of optimality (e.g., as indicated by utilizing input handling models 117) to process the input (e.g., to generate an output based on the input).

Unified AI/ML platform 101 may accordingly obtain (at 306) an output of AI/ML system 103-1 based on the input. For example, unified AI/ML platform 101 may forward the input (e.g., as provided at 302) by client device 105 to AI/ML system 103-1, AI/ML system 103-1 may perform one or more AI/ML techniques to generate an output based on the input, and may provide the output to unified AI/ML platform 101. In some embodiments, unified AI/ML platform 101 may sanitize, pre-process, or otherwise modify the input prior to providing the input to AI/ML system 103-1, and may provide the sanitized, pre-processed, modified, etc. to AI/ML system 103-1. In some embodiments, the sanitizing, pre-processing, modifying, etc. of the input may be performed based on information included in input handling models 117.

Unified AI/ML platform 101 may further forward (at 308) the output, provided by AI/ML system 103-1, to client device 105. In some embodiments, unified AI/ML platform 101 may further process, modify, etc. the output prior to providing the output to client device 105, and may provide the further processed, modified, etc. output to client device 105. In some embodiments, the processing, modifying, etc. of the output may be performed based on information included in input handling models 117. In this example, client device 105 may receive an optimal response to an input (e.g., a query, a request to process data, a request to perform image recognition, etc.) without needing to specify the optimal AI/ML system 103 to provide the response, and without even needing to be "aware" of the existence of AI/ML system 103-1 and/or other candidate AI/ML systems 103 such as AI/ML systems 103-2 and AI/ML system 103-M. Further, even in instances where client device 105 is "aware" of AI/ML systems 103-1, 103-2, and 103-M, the above-described example illustrates that client device 105 does not need to interface directly with AI/ML systems 103-1, 103-2, and/or 103-M in order to receive services, such as AI/ML processing services, from such AI/ML systems 103.

On the other hand, in some embodiments, client device 105 may explicitly include an indication that AI/ML system 103-1 should be selected to handle the request. In another example, UE policies (e.g., as provided by UPF 205) may indicate that AI/ML system 103-1 should be selected to handle this input and/or other inputs from client device 105, and/or such policies may be otherwise a factor based on which unified AI/ML platform 101 selected (at 304) AI/ML system 103-1 to handle the input. In some embodiments, one or more other factors may have been used by unified AI/ML platform 101 to select (at 304) AI/ML system 103-1 to handle the input (received at 302).

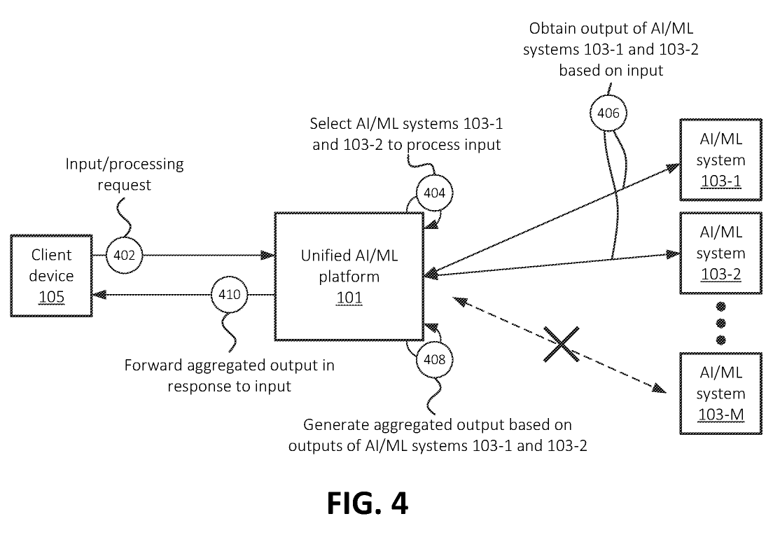

As noted above, an "optimal" set of AI/ML systems 103 for a given input may include multiple AI/ML systems 103. For example, as shown in FIG. 4, unified AI/ML platform 101 may select (at 404) multiple AI/ML systems 103 (e.g., AI/ML systems 103-1 and 103-2) to handle an input received (at 402) from client device 105. For example, as similarly noted above, content of the input may be factor based on which unified AI/ML platform 101 selects (at 404) multiple AI/ML systems 103 to handle the input. In one example, unified AI/ML platform 101 may identify (e.g., based on input handling models 117) that the input is a "hybrid" type of input, for which multiple different AI/ML systems 103 may be an optimal match for certain portions of the input, and/or for which multiple different AI/ML systems 103 exceed one or more optimality thresholds with respect to the input. In some embodiments, unified AI/ML platform 101 may determine that AI/ML systems 103-1 and 103-2 are an optimal match for the input based on factors in addition to, or in lieu of, the content of the input, such as UE information or policies and/or other external information that is not necessarily specifically tied to client device 105, as discussed above.

In some embodiments, unified AI/ML platform 101 may, for example, identify one or more measures of optimality (e.g., scores or other suitable values) of some or all AI/ML systems 103 to handle the input (e.g., where such measures of optimality may be generated based on input handling models 117), and may identify that AI/ML systems 103-1 and AI/ML system 103-2 are each associated with at least a threshold measure of optimality, that AI/ML systems 103-1 and 103-2 are associated with the highest measures of optimality out of a set of candidate AI/ML systems 103, etc.

In some embodiments, unified AI/ML platform 101 may select one or more AI/ML systems 103 to handle an input in one or more other ways. For example, as one example, unified AI/ML platform 101 may utilize a random or pseudo-random technique to select one or more AI/ML systems 103 to handle an input, and/or may utilize one or more random or pseudo-random value generators as a factor in performing such selections. In this manner, repeated inputs with the same or similar content or other attributes may end up being associated with varied responses, which may provide for a more robust and varied AI/ML solution.

Unified AI/ML platform 101 may generate (at 408) an aggregated output based on the outputs of AI/ML systems 103-1 and 103-2 (obtained at 406). For example, unified AI/ML platform 101 may perform further AI/ML processing or other suitable processing, using the outputs of AI/ML systems 103-1 and 103-2, and may generate an aggregated output that is based on the outputs of AI/ML system 103-1 and 103-2 based on such further processing. In some embodiments, unified AI/ML platform 101 may utilize a weighting factor when generating the aggregated output, which may be based on the above-described respective measure of optimality of AI/ML systems 103-1 and 103-2. For example, if AI/ML system 103-1 is associated with an optimality score of 80 and AI/ML system 103-2 is associated with an optimality score of 90, the aggregated output may be generated more heavily based on the output of AI/ML system 103-2 than of AI/ML system 103-1. Unified AI/ML platform 101 may proceed to forward (at 410) the aggregated output to client device 105.

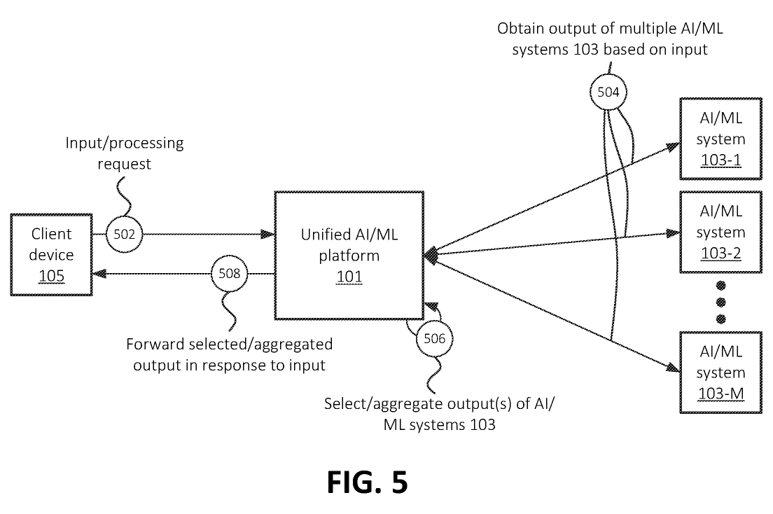

In some embodiments, as shown in FIG. 5, unified AI/ML platform 101 may perform a selection procedure after obtaining outputs (e.g., candidate outputs) from multiple AI/ML systems 103. For example, unified AI/ML platform 101 may receive (at 502) an input from client device 105, and may obtain (at 504) the output of multiple AI/ML systems 103 to the input. For example, unified AI/ML platform 101 may, prior to performing any sort of selection procedure in some embodiments, forward (at 504) the input (and/or a sanitized, pre-processed, etc. version of the input) to AI/ML systems 103-1, 103-2, and 103-M, and may receive responses from each such AI/ML system 103 (e.g., respective outputs of AI/ML systems 103 that were generated by AI/ML systems 103 based on the provided input).

Unified AI/ML platform 101 may analyze the received outputs (e.g., using AI/ML techniques or other suitable techniques), and may select (at 506) a particular output or set of outputs (e.g., may aggregate multiple outputs) based on, for example, measures of optimality, relatedness, correlation, etc. to the input and/or other information (e.g., content of the input, attributes of client device 105, etc.). As similarly noted above, unified AI/ML platform 101 may perform a weighting procedure based on, for example, optimality of the received outputs, in order to generate an aggregated output. Unified AI/ML platform 101 may proceed to forward (at 508) the selected and/or aggregated output(s) to client device 105.

Once client device 105 receives (e.g., at 112, 308, 410, and/or 510) a response to a given input, feedback may be provided to unified AI/ML platform 101 and used to further refine input handling models 117. Such feedback may include, for example, an indication of satisfaction of the output from a user of client device 105, subsequent actions taken by client device 105 (e.g., repeating the same or similar inputs may indicate a potential sub-optimal response was previously provided), and/or other suitable information may be used to further refine input handling models 117 in order to continuously improve the selection by unified AI/ML platform 101 of an appropriate set of AI/ML systems 103 to handle inputs from client devices 105.

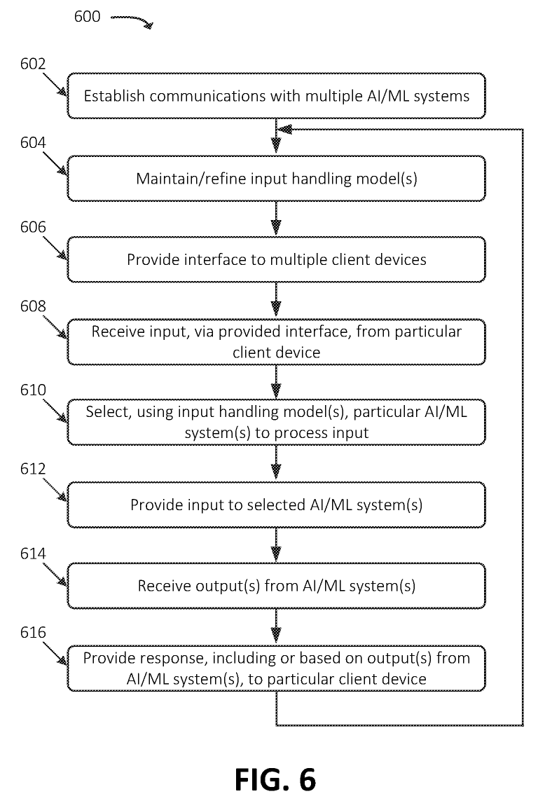

FIG. 6 illustrates an example process 600 for providing a seamless unified API that facilitates access to processing services of multiple AI/ML systems. In some embodiments, some or all of process 600 may be performed by unified AI/ML platform 101.

As shown, process 600 may include establishing (at 602) communications with multiple AI/ML systems 103. As discussed above, establishing communications with a particular AI/ML system 103 may include performing a registration procedure to register, authenticate, etc. unified AI/ML platform 101 with the particular AI/ML system 103. Establishing communications may include implementing an API, associated with the particular AI/ML system 103, by unified AI/ML platform 101 and/or performing other configuration actions by unified AI/ML platform 101 in order to facilitate communications with AI/ML system 103. In some scenarios, these types of APIs or other communication pathways may be implemented by unified AI/ML platform 101, such that client devices 105 that receive services from unified AI/ML platform 101 do not need to implement such APIs or other communication pathways with AI/ML systems 103. That is, in some situations, one or more APIs or other communication pathways, used by unified AI/ML platform 101 to communicate with one or more AI/ML systems 103, may not be implemented by one or more client devices 105.

Process 600 may further include maintaining and/or refining (at 604) one or more input handling models 117. For example, as discussed above, input handling models 117 may associate client device attributes (e.g., which may include UE attribute information, UE policies, UE communication session information, etc.), input attributes, and/or other information which may not necessarily be dependent on or otherwise tied to client devices 105 or inputs provided by client devices 105, such as weather information, road traffic information, load information or other Key Performance Indicators ("KPIs") of wireless network 111, and/or information. As discussed above, input handling models 117 may associate such information with designations of one or more AI/ML systems 103, denoting that inputs (e.g., as received from client devices 105) that meet certain input criteria should be provided to one or more AI/ML systems 103 that meet certain output criteria (e.g., AI/ML systems 103 that handle a particular type of input, AI/ML systems 103 that are specifically indicated by input handling models 117, etc.).

Process 600 may additionally include providing (at 606) an interface to multiple client devices 105. For example, as discussed above, unified AI/ML platform 101 may provide, implement, etc. unified API 107. In this manner, client devices 105 need only register with or otherwise communicate with unified AI/ML platform 101 in order to ultimately receive AI/ML services from multiple AI/ML systems 103. In one example, one particular client device 105 may access unified AI/ML platform 101 via unified API 107 (e.g., via multiple secure sessions), such as multiple applications executing on the particular client device 105 concurrently accessing unified AI/ML platform 101 via unified API 107.

Process 600 may also include receiving (at 608) an input, via the provided unified API 107, from a particular client device 105. For example, as discussed above, client device 105 may provide an input such as a natural language prompt, an image recognition request, a processing request, and/or some other suitable type of input. In some embodiments, the input may include (or client device 105 may otherwise provide) a preference or some other indication of particular AI/ML techniques to utilize in handling the input, and/or of one or more particular AI/ML systems 103 to handle the input. On the other hand, in some embodiments, the input may not include (or client device 105 may not otherwise provide) such preference or indication.

Process 600 may further include selecting (at 610), using input handling models 117, one or more particular AI/ML systems 103 to handle the input. For example, as discussed above, unified AI/ML platform 101 may select one AI/ML system 103 to handle the input, may select multiple but fewer than all available AI/ML systems 103 (e.g., a subset of all candidate AI/ML systems 103), and/or may select all available AI/ML systems 103 to handle the input and/or portions thereof. For example, in some embodiments, unified AI/ML platform 101 may select one AI/ML system 103 to handle one portion of the input, may select another AI/ML system 103 to handle another portion of the input, etc. Additionally, or alternatively, unified AI/ML platform 101 may select multiple AI/ML systems 103 to handle the entire input and/or the same portion(s) of the input. In some embodiments, unified AI/ML platform 101 may identify, based on input handling models 117, a sequence of AI/ML systems 103 to handle the input or portions thereof. For example, unified AI/ML platform 101 may identify that a first AI/ML system 103-1 should handle a first portion of the input, that a second AI/ML system 103-2 should handle a second portion of the input and/or an output of AI/ML system 103-1, etc. In some embodiments, unified AI/ML platform 101 may select or identify AI/ML system(s) 103 in some other suitable manner, using input handling models 117.

In this sense, unified AI/ML platform 101 may itself utilize one or more AI/ML techniques to select one or more AI/ML systems 103 to handle the input. As discussed above, unified AI/ML platform 101 may refine input handling models 117 over time in order to improve or refine the manner in which unified AI/ML platform 101 selects AI/ML systems 103 to handle respective inputs, thus ensuring that unified AI/ML platform 101 is able to optimally route inputs to respective AI/ML systems 103, in order to provide an optimal output in response to such inputs.

Process 600 may additionally include providing (at 612) the input, and/or portions thereof, to one or more AI/ML systems 103. For example, unified AI/ML platform 101 may provide the input, and/or selected portions, to respective selected AI/ML systems 103 via one or more suitable APIs or other communication pathways that were established (at 602) with such AI/ML systems 103.

Process 600 may also include receiving (at 614) one or more outputs, from the selected one or more AI/ML systems 103. For example, each AI/ML system 103 of the selected subset of AI/ML systems 103 (or a single AI/ML system 103, in some situations) may perform AI/ML processing on the provided input, and may provide respective outputs based on such AI/ML processing.

Process 600 may further include providing (at 616) a response, including or based on the outputs from AI/ML systems 103, to client device 105. For example, as discussed above, unified AI/ML platform 101 may select a particular output of a particular AI/ML system 103, may aggregate outputs of multiple AI/ML systems 103, may provide the output of multiple AI/ML systems 103, and/or may otherwise generate, identify, select, etc. an output to provide to client device 105 in response to the input.

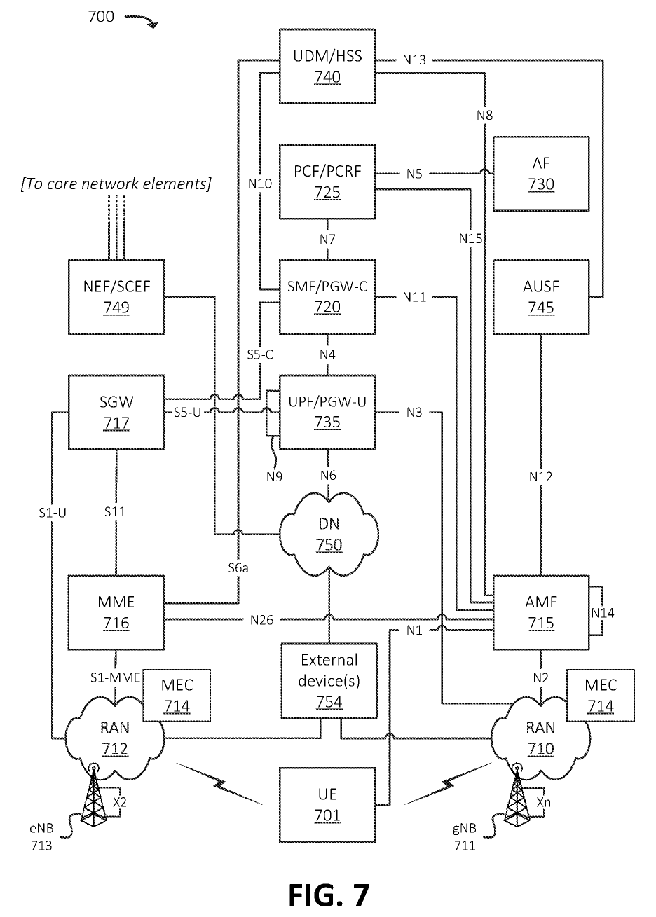

FIG. 7 illustrates an example environment 700, in which one or more embodiments may be implemented. In some embodiments, environment 700 may correspond to a Fifth Generation ("5G") network, and/or may include elements of a 5G network. In some embodiments, environment 700 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 700 may represent or may include a 5G core ("5GC"). As shown, environment 700 may include UE 701, RAN 710 (which may include one or more Next Generation Node Bs ("gNBs") 711), RAN 712 (which may include one or more evolved Node Bs ("eNBs") 713), and various network functions such as Access and Mobility Management Function ("AMF") 715, Mobility Management Entity ("MME") 716, Serving Gateway ("SGW") 717, Session Management Function ("SMF")/Packet Data Network ("PDN") Gateway ("PGW")-Control plane function ("PGW-C") 720, PCF/Policy Charging and Rules Function ("PCRF") 725, Application Function ("AF") 730, UPF/PGW-User plane function ("PGW-U") 735, UDM/Home Subscriber Server ("HSS") 740, Authentication Server Function ("AUSF") 745, and NEF/Service Capability Exposure Function ("SCEF") 749. Environment 700 may also include one or more networks, such as Data Network ("DN") 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple "slices" of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service ("QoS") parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions ("VNFs"), Cloud-Native Network Functions ("CNFs"), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®} application programming interface ("API") or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces ("SBIs"), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to wireless network 111.

UE 701 may include a computation and communication device, such as a wireless mobile communication device that is capable of communicating with RAN 710, RAN 712, and/or DN 750. UE 701 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 701 may send traffic to and/or receive traffic (e.g., user plane traffic) from DN 750 via RAN 710, RAN 712, and/or UPF/PGW-U 735. As discussed above, in some embodiments, UE 701 may include, may implement, may be implemented by, and/or may otherwise be associated with one or more client devices 105.

RAN 710 may be, or may include, a 5G RAN that implements a 5G RAT and that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface.

RAN 712 may be, or may include, an LTE RAN that implements an LTE RAT and that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface.

One or more RANs of environment 700 (e.g., RAN 710 and/or RAN 712) may include, may implement, and/or may otherwise be communicatively coupled to one or more edge computing devices, such as one or more MECs 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 701, via RAN 710 and/or 712. For example, RAN 710 and/or 712 may route some traffic from UE 701 (e.g., traffic associated with one or more particular services, applications, application types, etc.) to a respective MEC 714 instead of to core network elements of 700 (e.g., UPF/PGW-U 735). MEC 714 may accordingly provide services to UE 701 by processing such traffic, performing one or more computations based on the received traffic, and providing traffic to UE 701 via RAN 710 and/or 712. MEC 714 may include, and/or may implement, some or all of the functionality described above with respect to unified AI/ML platform 101, one or more AI/ML systems 103, UPF/PGW-U 735, AF 730, one or more application servers, and/or one or more other devices, systems, VNFs, CNFs, etc. In this manner, ultra-low latency services may be provided to UE 701, as traffic does not need to traverse links (e.g., backhaul links) between RAN 710 and/or 712 and the core network.

AMF 715 may include one or more devices, systems, VNFs, CNFs, etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked "N14" originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple instances of UPF/PGW-U 735 may be deployed (e.g., in different geographical locations), and the delivery of content to UE 701 may be coordinated via the N9 interface (e.g., as denoted in FIG. 7 by the line marked "N9" originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository ("UDR"). AUSF 745 and/or UDM/HSS 740 may perform authentication, authorization, and/or accounting operations associated with one or more UEs 701 and/or one or more communication sessions associated with one or more UEs 701.

DN 750 may include one or more wired and/or wireless networks. For example, DN 750 may include an IP-based PDN, a wide area network ("WAN") such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network ("PSTN"), a public land mobile network ("PLMN"), and/or another network. DN 750 may be connected to one or more devices, such as content providers, applications, web servers, and/or other devices, with which UE 701 may communicate.

External devices 754 may include one or more devices or systems that communicate with UE 701 via DN 750 and one or more elements of 700 (e.g., via UPF/PGW-U 735). In some embodiments, external devices 754 may include, may implement, and/or may otherwise be associated with client devices 105, AI/ML systems 103, unified AI/ML platform 101, application servers 113, and/or database 115. External devices 754 may include, for example, one or more application servers, content provider systems, web servers, or the like. External devices 754 may, for example, implement "server-side" applications that communicate with "client-side" applications executed by UE 701. External devices 754 may provide services to UE 701 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy ("SEPP"), which may perform some or all of the functions discussed above. External device 754 may, in some situations, subscribe to particular types of requested information provided by the one or more core network elements, and the one or more core network elements may provide (e.g., "push") the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements ("SLAs"), etc. (e.g., maximum latency thresholds, minimum throughput thresholds, etc.) associated with the services.

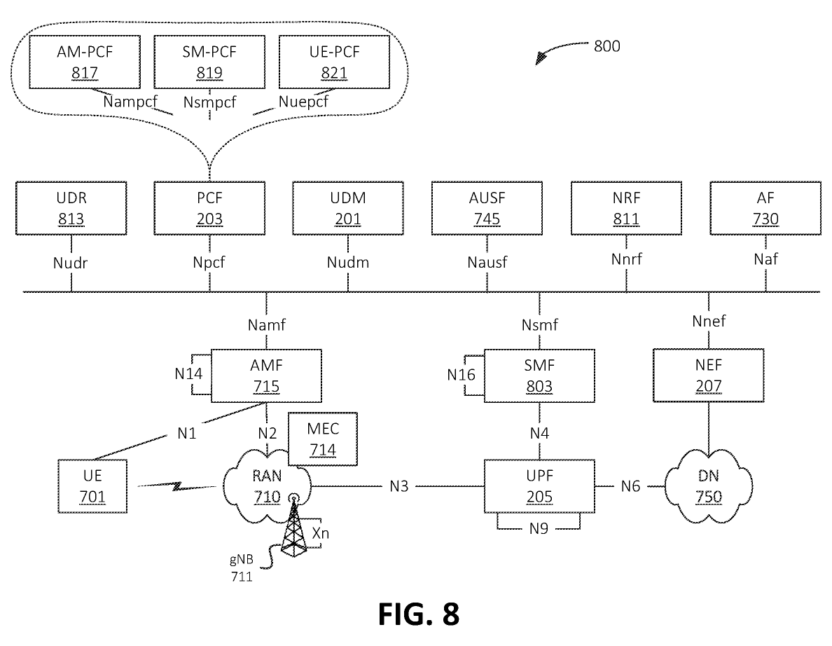

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 701, RAN 710 (which may include one or more gNBs 711 or other types of wireless network infrastructure) and various network functions, which may be implemented as VNFs, CNFs, etc. Such network functions may include AMF 715, SMF 803, UDM 201, PCF 203, UPF 205, AUSF 745, Network Repository Function ("NRF") 811, AF 730, UDR 813, and NEF 207. Environment 800 may also include or may be communicatively coupled to one or more networks, such as DN 750.

The example shown in FIG. 8 illustrates one instance of each network component or function (e.g., one instance of SMF 803, UPF 205, PCF 203, UDM 201, AUSF 745, etc.). In practice, environment 800 may include multiple instances of such components or functions. For example, in some embodiments, environment 800 may include multiple "slices" of a core network, where each slice includes a discrete and/or logical set of network functions (e.g., one slice may include a first instance of SMF 803, PCF 203, UPF 205, etc., while another slice may include a second instance of SMF 803, PCF 203, UPF 205, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 201), an Npcf interface, an Nupf interface, an Nnef interface, an Nsmf interface, an Nnrf interface, an Nudr interface, an Naf interface, and/or one or more other SBIs. In some embodiments, environment 800 may be, may include, may be implemented by, and/or may be communicatively coupled to wireless network 111.

UPF 205 may include one or more devices, systems, VNFs, CNFs, etc., that receive, route, process, and/or forward traffic (e.g., user plane traffic). As discussed above, UPF 205 may communicate with UE 701 via one or more communication sessions, such as PDU sessions. Such PDU sessions may be associated with a particular network slice or other suitable QoS parameters, as noted above. UPF 205 may receive downlink user plane traffic (e.g., voice call traffic, data traffic, etc. destined for UE 701) from DN 750, and may forward the downlink user plane traffic toward UE 701 (e.g., via RAN 710). In some embodiments, multiple UPFs 205 may be deployed (e.g., in different geographical locations), and the delivery of content to UE 701 may be coordinated via the N9 interface. Similarly, UPF 205 may receive uplink traffic from UE 701 (e.g., via RAN 710), and may forward the traffic toward DN 750. In some embodiments, UPF 205 may implement, may be implemented by, may be communicatively coupled to, and/or may otherwise be associated with UPF/PGW-U 735. In some embodiments, UPF 205 may communicate (e.g., via the N4 interface) with SMF 803, regarding user plane data processed by UPF 205 (e.g., to provide analytics or reporting information, to receive policy and/or authorization information, etc.).

PCF 203 may include one or more devices, systems, VNFs, CNFs, etc., that aggregate, derive, generate, etc. policy information associated with the 5GC and/or UEs 701 that communicate via the 5GC and/or RAN 710. PCF 203 may receive information regarding policies and/or subscriptions from one or more sources, such as subscriber databases (e.g., UDM 201, UDR 813, etc.), and/or from one or more users such as, for example, an administrator associated with PCF 203. In some embodiments, the functionality of PCF 203 may be split into multiple network functions or subsystems, such as access and mobility PCF ("AM-PCF") 817, session management PCF ("SM-PCF") 819, UE PCF ("UE-PCF") 821, and so on. Such different "split" PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 203 and/or other elements of environment 800 may determine access policies, QoS policies, charging policies, or the like. In some embodiments, UDR 813 may receive such information from UDM 201 and/or one or more other sources.

NEF 207 include one or more devices, systems, VNFs, CNFs, etc. that provide access to information, APIs, and/or other operations or mechanisms of the 5GC to devices or systems that are external to the 5GC. NEF 207 may maintain authorization and/or authentication information associated with such external devices or systems, such that NEF 207 is able to provide information, that is authorized to be provided, to the external devices or systems. Such information may be received from other network functions of the 5GC (e.g., as authorized by an administrator or other suitable entity associated with the 5GC), such as SMF 803, UPF 205, a charging function ("CHF") of the 5GC, and/or other suitable network function. NEF 207 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 203 may include, may implement, may be implemented by, and/or may otherwise be associated with a PCRF (e.g., PCF/PCRF 725); NEF 207 may include, may implement, may be implemented by, and/or may otherwise be associated with a SCEF (e.g., NEF/SCEF 749); and so on.

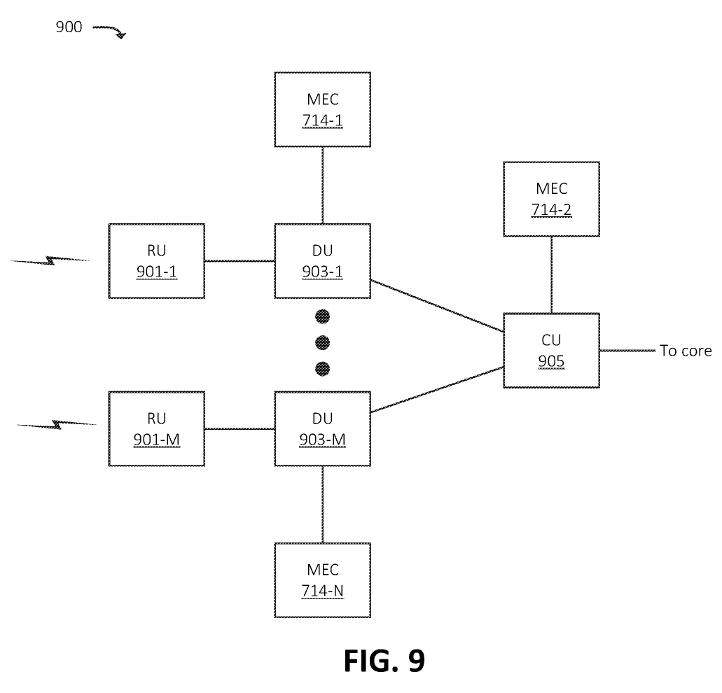

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit ("CU") 905, one or more Distributed Units ("DUs") 903-1 through 903-M (referred to individually as "DU 903," or collectively as "DUs 903"), and one or more Radio Units ("RUs") 901-1 through 901-M (referred to individually as "RU 901," or collectively as "RUs 901").

CU 905 may communicate with a core of a wireless network (e.g., may communicate with one or more of the devices or systems described above with respect to FIG. 8, such as AMF 715 and/or UPF 205) and/or some other device or system such as MEC 714. In the uplink direction (e.g., for traffic from UEs 701 to a core network), CU 905 may aggregate traffic from DUs 903, and forward the aggregated traffic to the core network. In some embodiments, CU 905 may receive traffic according to a given protocol (e.g., Radio Link Control ("RLC") traffic) from DUs 903, and may perform higher-layer processing (e.g., may aggregate/process RLC packets and generate Packet Data Convergence Protocol ("PDCP") packets based on the RLC packets) on the traffic received from DUs 903.

CU 905 may receive downlink traffic (e.g., traffic from the core network, traffic from a given MEC 714, etc.) for a particular UE 701, and may determine which DU(s) 903 should receive the downlink traffic. DU 903 may include one or more devices that transmit traffic between a core network (e.g., via CU 905) and UE 701 (e.g., via a respective RU 901). DU 903 may, for example, receive traffic from RU 901 at a first layer (e.g., physical ("PHY") layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 701.

RU 901 may include hardware circuitry (e.g., one or more RF transceivers, antennas, radios, and/or other suitable hardware) to communicate wirelessly (e.g., via an RF interface) with one or more UEs 701, one or more other DUs 903 (e.g., via RUs 901 associated with DUs 903), and/or any other suitable type of device. In the uplink direction, RU 901 may receive traffic from UE 701 and/or another DU 903 via the RF interface and may provide the traffic to DU 903. In the downlink direction, RU 901 may receive traffic from DU 903, and may provide the traffic to UE 701 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 701, via a respective RU 901.

For example, DU 903-1 may route some traffic, from UE 701, to MEC 714-1 instead of to a core network via CU 905. MEC 714-1 may process the traffic, perform one or more computations based on the received traffic, and may provide traffic to UE 701 via RU 901-1. As discussed above, MEC 714 may include, and/or may implement, some or all of the functionality described above with respect to UPF 205, AF 730, and/or one or more other devices, systems, VNFs, CNFs, etc. In this manner, ultra-low latency services may be provided to UE 701, as traffic does not need to traverse DU 903, CU 905, links between DU 903 and CU 905, and an intervening backhaul network between RAN environment 900 and the core network.

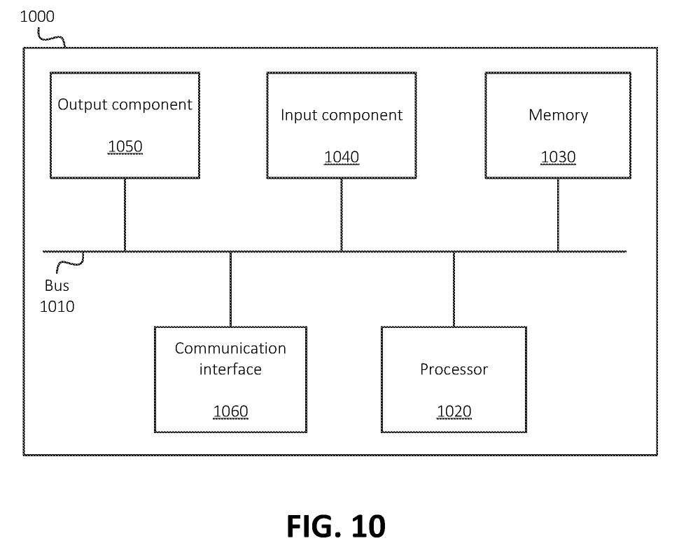

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes ("LEDs"), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
establish communications with a plurality of artificial intelligence/machine learning ("AI/ML") systems;
provide an interface to a plurality of client devices;
receive, via the interface and from a particular client device, of the plurality of client devices, a particular input;
select, based on one or more input handling models, a particular subset of AI/ML systems, of the plurality of AI/ML systems, to which the particular input should be forwarded;
output, to the selected subset of AI/ML systems, the particular input;
receive, from the selected subset of AI/ML systems, a set of outputs that are each associated with a particular AI/ML system of the selected subset of AI/ML systems; and
output, via the interface and to the particular client device, at least one of:
one or more outputs, of the set of outputs received from the selected subset of AI/ML systems, or
an aggregated output that is generated based on the set of outputs received from the selected subset of AI/ML systems.

2. The device of claim 1, wherein the plurality of AI/ML systems include a plurality of large language model ("LLM") systems.

3. The device of claim 1, wherein selecting the particular subset of AI/ML systems based on the input handling model includes utilizing one or more AI/ML techniques, associated with the input handling model, to select the particular subset of AI/ML systems.

4. The device of claim 1, wherein the one or more processors are further configured to:
receive at least one of:
User Equipment ("UE") attribute information, associated with the particular client device, from a network with which the particular client device is registered,
UE policy information, associated with the particular client device, from the network with which the particular client device is registered, or
communication session information, associated with one or more communication sessions between the particular client device and the network,
wherein selecting the particular subset of AI/ML systems is further based on the at least one of the received UE attribute information, UE policy information, or communication session information.

5. The device of claim 4, wherein the communication session information includes one or more network slices associated with the one or more communication sessions between the particular client device and the wireless network.

6. The device of claim 1, wherein at least two AI/ML systems, of the plurality of AI/ML systems, implement different AI/ML techniques.

7. The device of claim 1, wherein the interface includes a first application programming interface ("API"), wherein establishing communications with the plurality of AI/ML systems includes implementing at least a second API, associated with one or more AI/ML systems of the plurality of AI/ML systems, wherein the second API is not implemented by the particular client device.

8. A non-transitory computer-readable medium, storing a plurality of processor-executable instructions to:
establish communications with a plurality of artificial intelligence/machine learning ("AI/ML") systems;
provide an interface to a plurality of client devices;
receive, via the interface and from a particular client device, of the plurality of client devices, a particular input;
select, based on one or more input handling models, a particular subset of AI/ML systems, of the plurality of AI/ML systems, to which the particular input should be forwarded;
output, to the selected subset of AI/ML systems, the particular input;
receive, from the selected subset of AI/ML systems, a set of outputs that are each associated with a particular AI/ML system of the selected subset of AI/ML systems; and
output, via the interface and to the particular client device, at least one of:
one or more outputs, of the set of outputs received from the selected subset of AI/ML systems, or
an aggregated output that is generated based on the set of outputs received from the selected subset of AI/ML systems.

9. The non-transitory computer-readable medium of claim 8, wherein the plurality of AI/ML systems include a plurality of large language model ("LLM") systems.

10. The non-transitory computer-readable medium of claim 8, wherein selecting the particular subset of AI/ML systems based on the input handling model includes utilizing one or more AI/ML techniques, associated with the input handling model, to select the particular subset of AI/ML systems.

11. The non-transitory computer-readable medium of claim 8, wherein the plurality of processor-executable instructions further include processor-executable instructions to:
receive at least one of:
User Equipment ("UE") attribute information, associated with the particular client device, from a network with which the particular client device is registered,
UE policy information, associated with the particular client device, from the network with which the particular client device is registered, or
communication session information, associated with one or more communication sessions between the particular client device and the network,
wherein selecting the particular subset of AI/ML systems is further based on the at least one of the received UE attribute information, UE policy information, or communication session information.

12. The non-transitory computer-readable medium of claim 11, wherein the communication session information includes one or more network slices associated with the one or more communication sessions between the particular client device and the wireless network.

13. The non-transitory computer-readable medium of claim 8, wherein at least two AI/ML systems, of the plurality of AI/ML systems, implement different AI/ML techniques.

14. The non-transitory computer-readable medium of claim 8, wherein the interface includes a first application programming interface ("API"), wherein establishing communications with the plurality of AI/ML systems includes implementing at least a second API, associated with one or more AI/ML systems of the plurality of AI/ML systems, wherein the second API is not implemented by the particular client device.

15. A method, comprising:
establishing communications with a plurality of artificial intelligence/machine learning ("AI/ML") systems;
providing an interface to a plurality of client devices;
receiving, via the interface and from a particular client device, of the plurality of client devices, a particular input;
selecting, based on one or more input handling models, a particular subset of AI/ML systems, of the plurality of AI/ML systems, to which the particular input should be forwarded;
outputting, to the selected subset of AI/ML systems, the particular input;
receiving, from the selected subset of AI/ML systems, a set of outputs that are each associated with a particular AI/ML system of the selected subset of AI/ML systems; and
outputting, via the interface and to the particular client device, at least one of:
one or more outputs, of the set of outputs received from the selected subset of AI/ML systems, or
an aggregated output that is generated based on the set of outputs received from the selected subset of AI/ML systems.

16. The method of claim 15, wherein the plurality of AI/ML systems include a plurality of large language model ("LLM") systems.

17. The method of claim 15, wherein selecting the particular subset of AI/ML systems based on the input handling model includes utilizing one or more AI/ML techniques, associated with the input handling model, to select the particular subset of AI/ML systems.

18. The method of claim 15, further comprising:
receiving at least one of:
User Equipment ("UE") attribute information, associated with the particular client device, from a network with which the particular client device is registered,
UE policy information, associated with the particular client device, from the network with which the particular client device is registered, or
communication session information, associated with one or more communication sessions between the particular client device and the network, wherein the communication session information includes one or more network slices associated with the one or more communication sessions between the particular client device and the network,
wherein selecting the particular subset of AI/ML systems is further based on the at least one of the received UE attribute information, UE policy information, or communication session information.

19. The method of claim 15, wherein at least two AI/ML systems, of the plurality of AI/ML systems, implement different AI/ML techniques.

20. The method of claim 15, wherein the interface includes a first application programming interface ("API"), wherein establishing communications with the plurality of AI/ML systems includes implementing at least a second API, associated with one or more AI/ML systems of the plurality of AI/ML systems, wherein the second API is not implemented by the particular client device.
